(19) United States
(12) Patent Application Publication
(10) Pub. No.: US 2002/0139047 A1
(43) Pub. Date: Oct. 3, 2002

(54) Composite wood planters, post caps and other containers

(76) Inventors: Joseph Francis Haddad, Millington, NJ (US); Philip Laracy Haddad, Basking Ridge, NJ (US)

Correspondence Address: Philip L. Haddad, 105 Penwood Rd., Basking Ridge, NJ, 07920, US

(21) Appl. No.: 09/818,924

(22) Filed: Mar. 27, 2001

(51) Int. Cl. A01G 9/02

(52) U.S. Cl. 47/66.1

(57) ABSTRACT

This invention relates to certain container type products, specifically planters consisting of four or more sides and a bottom, and post caps consisting of four sides and a lid. This invention provides for constructing said products by joining components that are milled from composite wood extruded stock using conventional wood milling methods. Products so constructed possess present wood or plastic commercial products. A joining method for the component parts that employs dove-tailed grooves and channels and requires no adhesives, nails or other fastening devices is provided.

### BACKGROUND OF THE INVENTION

1. Field of the Invention

This invention relates generally to decorative containers constructed by joining components milled from composite wood, specifically including planters and post caps.

2. Description of Related Art

Decorative planers are containers intended to hold soil, water, fertilizer and other media to support plant growth and maintenance. They are used primarily outdoors to decorate porches, decks, patios, and walkways. Through shaped planters, commonly referred to as flower boxes, are hung from window frames as well as from porch and deck railing or can be free standing.

Because of its aesthetic appeal, wood has been the preferred material for planters. However, one piece molded or cast plastics now dominate the planters market due to superior wear characteristics and low production costs. Ceramics and metals find limited use.

Wooden planters must be lined, usually with plastic film, to protect the inner surfaces from soil contact. The exterior surfaces of wooden planters require maintenance, such as painting staining or water-proofing. Also, compared to plastics, wooden planter construction is slow and labor intensive. These drawbacks limit wood to a small, specialty niche of the market for these products and have helped plastics gain a large share.

Patent literature on planters, including flower boxes, tends to deal with shape or design rather than materials and methods of construction and applies generally to molded plastics. U.S. Pat. No. 3,987,924 describes a plastic walled structure that can be insulated and used as a flower box. U.S. Des. 263,291 and also U.S. Des. 265,387 both claim ornamental designs for trough-like planters. U.S. Des. 265 893 claims an ornamental design for a combined modular flower box and tray.

There are two types of post caps. “Slip on” post caps are square containers with a lid rather than a bottom. They are fitted onto the top of posts to provide aesthetic appeal as well as to protect the post tops that they contain. “Non-slip on” post caps are not containers but rather are solid shaped and intended to be attached to the horizontal surface of post tops. Wood and plastics have been the materials of construction for both types of post caps. Our patent application Ser. No. 09/661,046 of Sep. 14, 2000 describes innovative “non-slip on” post caps and post cap systems for use with composite wood decks particularly those with wooden posts enclosed in composite wood wrap. The present invention concerns the “slip on ” cap.

The material of construction in this invention, composite wood, is also referred to as “plastic wood” or “synthetic wood” (U.S. Pat. Nos. 5,088,910 and 5,082,605). Developed as a construction material in the early 90's, it was initially sold for window and door frames and has since found increasing use as deck flooring and railing. In weather exposed applications its value-in-use is very competitive with the natural woods because it has superior weather resistance and requires no painting, or other maintenance. It is considered environmentally friendly since it makes use of recycled rather than virgin materials.

Composite wood is manufactured from a blend of plastic, such as polyethylene, and wood fibers, such as cedar. It is extruded in lengths having standard lumber nominal cross sectional dimensions such as “2×4”, and “1¼×6” for deck and porch floors and rails, and “½×6” for rail post wrap. It is common practice to use natural wood for structural posts and cover them with ½ composite wood “wrap” when using composite wood for deck floors and rails.

### SUMMARY OF THE INVENTION

The primary objective of this invention is to make planters, post caps and other decorative containers that have the aesthetic appeal of wood, are maintenance free, and have costs competitive with plastics. We have sought to achieve this by choosing composite wood as our construction material because of its proven endurance characteristics as deck flooring.

We have found that certain composite wood products, such as “Choicedek”, possess fine milling properties superior to wood. Largely because these products have a uniform, grain free texture, they can be routed and shaped with detailed accuracy. Unlike wood, surface texture in sharply angled corners and tight curves is clean and smooth regardless of direction. In general, hand or high speed automated milling of these composite wood yields consistently good surfaces that require no sanding or finishing.

Unlike natural wood products, composite wood containers, including planters and post caps, require no maintenance such as periodic waterproofing, staining, or painting. They remain dimensionally stable and will not warp with age even in extreme weather conditions.

Unlike natural wood planters, those of composite wood need no lining.

We have also found that the flex and compression properties of certain composite woods differ from those of wood, making possible a unique method for readily joining parts without tools, glue or nails. Thus products cap be sold for home assembly. This represents considerable cost savings by eliminating assembly costs and greatly reducing shipping costs. This joining method is fully explained by the drawings and their detailed description below.

A principal embodiment of this invention is a four-sided rectangular planter whose component parts are cut and decoratively shaped from extruded composite wood stock using conventional wood milling equipment. A post cap variation of this embodiment has four equal, decoratively profiled sides and an attached, decoratively shaped lid. Another variation is a rectangular storage container with a bottom and a removable lid.

### BRIEF DESCRIPTION OF THE DRAWINGS

FIG. 1 is a perspective view of a flower box planter for mounting to a vertical surface such as a deck rail, fence, or window frame. The figure illustrates the basic five piece trough-like structure of this embodiment. The two end pieces are vertical and support the two side pieces to which a rectangular bottom piece is attached. One side piece is vertical and the other is angled so that the box is narrower at the bottom than at the top.

FIG. 1A illustrates the dove-tailed tabs and grooves of this invention that are used to join the five pieces of the flower box of FIG. 1.

FIG. 2 is a free-standing flower box embodiment with angled end pieces and vertical sides.

FIG. 2A is a view of the unassembled pieces of the free standing box in FIG. 2 that shows the tab and channel layout for this embodiment.

FIG. 3 is a close view of this invention's tab and channel design detail.

FIG. 4 illustrates the dove-tail tab and groove joint of this invention for flush corners.

FIG. 5 illustrates this invention's assembly procedure.

FIG. 6 is a side view of a five piece post cap. The cap has four equal, sides attached to an overlapping lid. It is a “slip on” cap, that is, it is intended to be placed on a post so that the post top fits snugly into the cap.

### DESCRIPTION OF PREFERRED EMBODIMENTS

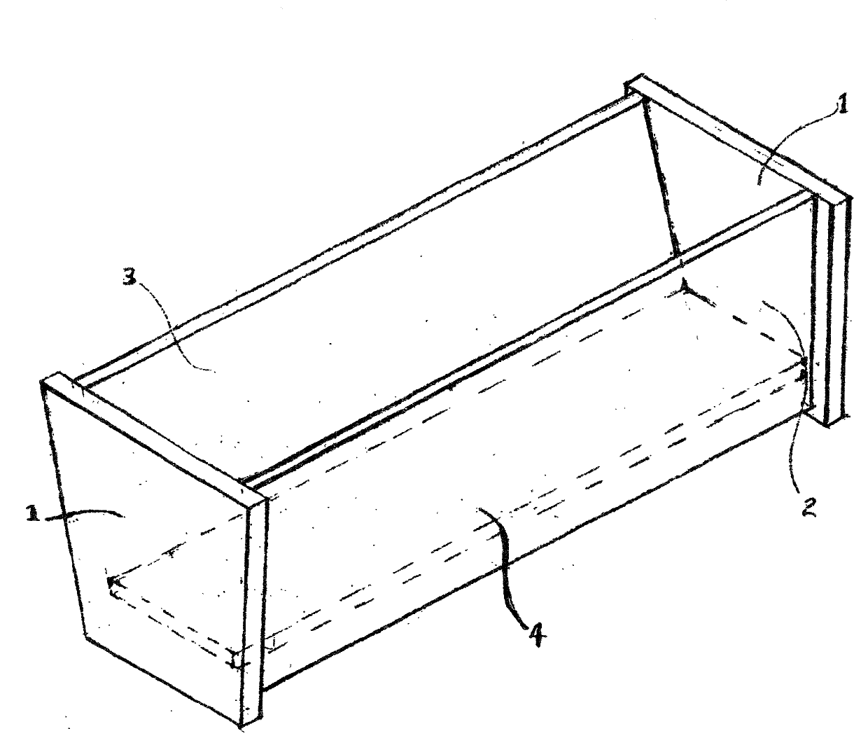

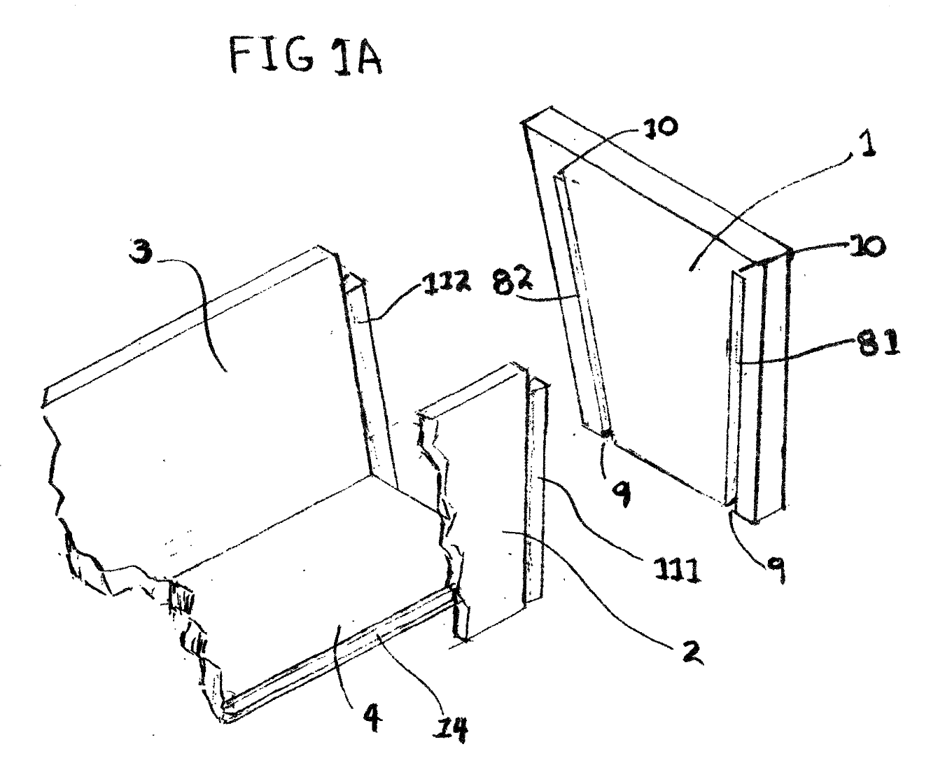

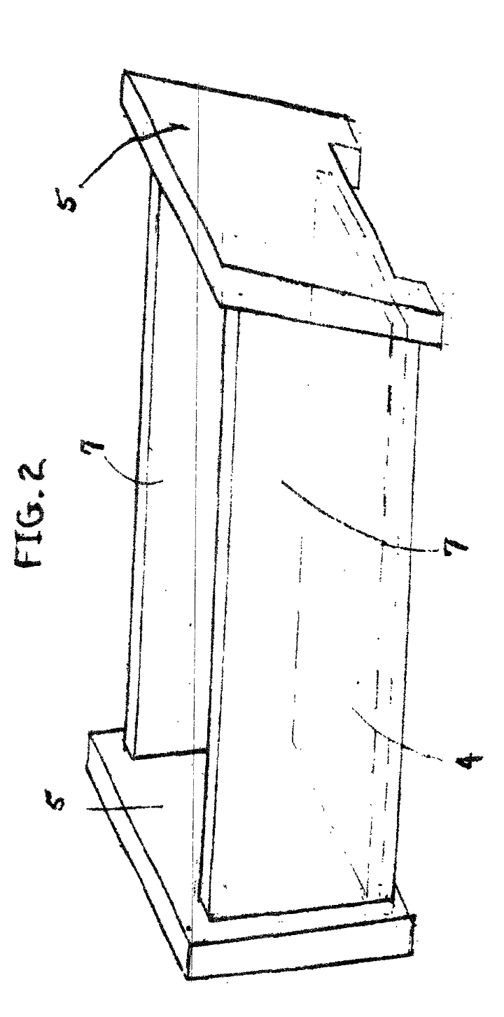

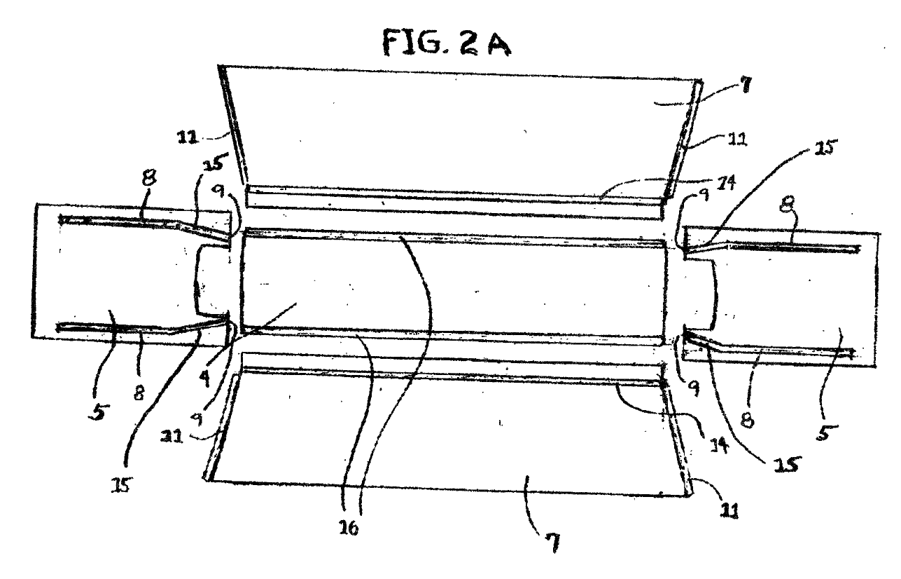

The principal embodiment of this invention is the rectangular flower box illustrated in FIGS. 1 and 2. The box has five component parts, four walls and a bottom. In FIG. 1 the end walls 1 and the rear wall 2 are perpendicular. The front wall 3 is angled slightly so that the top of the box is wider than the bottom 4. This type of box is intended to be mounted to a vertical surface such as a sill or rail. FIG. 2 illustrates a free standing box. Both end walls 5 are angled so that the top of the box is wider than the bottom 4. The two side walls 7 are perpendicular.

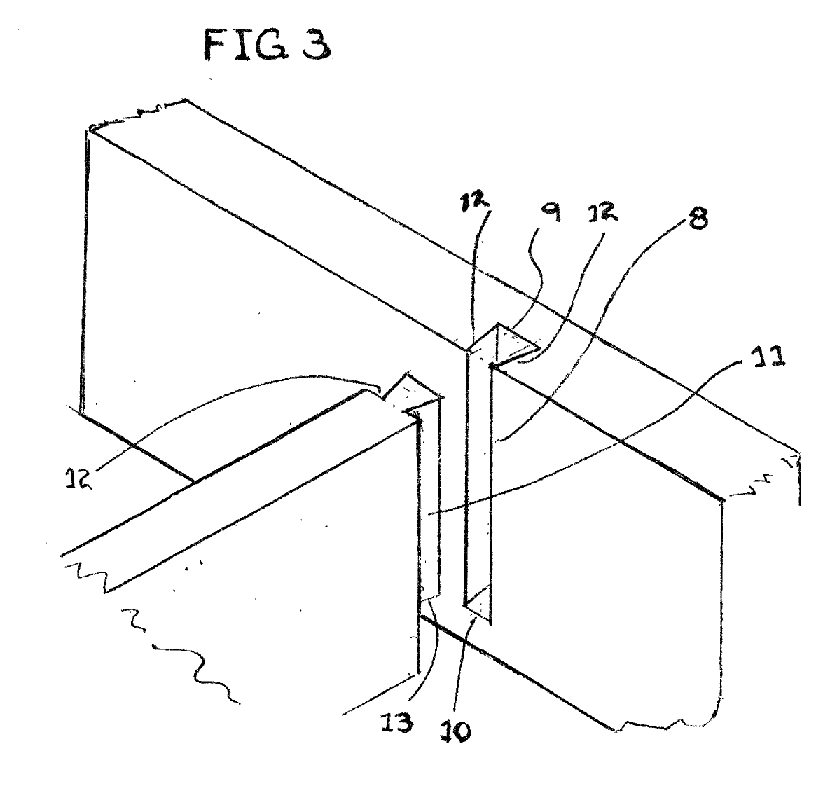

FIG. 3 shows the structure of this invention's joining system that applies to all rectangular embodiments. A receiving channel 8 must have at least one open end 9. The channel's side walls 12 converge slightly so that the channel opening is narrower than the real wall 9. The illustrated channel has a closed end 10. A tab 11 on the joining piece has a dove-tailed profile similar to the receiving channel, the neck being its narrowest point. The two components are joined by sliding one end, 13, of the tab 11 into the open end 9 of the channel and tapping the joining piece until its tab is seated at the channel end 10.

FIGS. 1A and 2A show the layouts of this invention's channel and tab system for the wall mount embodiment, FIG. 1, and the free standing embodiment of FIG. 2, respectively.

In FIG. 1A, of the wall mount embodiment, the end piece 1 contains the joining channels 81, 82 for the tabs 111, 112 of the rear wall 2 and side wall 3. The channels are not parallel but purposely converge slightly toward their open ends 9 in order to secure the joints by preventing the tabs from shipping out of the channels after assembly. The box bottom 4 has parallel grooves 12 for joining it to the walls 2 and 3, and the corresponding channels 14 on walls 2 and 3 of the box are open ended.

The assembly procedure for the wall mount embodiment is to join sides 2 and 3 to the bottom first, then join the ends 1 to the sides by firmly tapping them until the tabs 111, and 112 reach the closed ends 10 of their respective channels 81 and 82.

This invention's channel layout of the free-standing embodiment, FIG. 2, is shown in FIG. 2A. The box side walls 7, end walls 5 and bottom 4 are shown unassembled. The two channels 8 in the end walls 5 are parallel to each other for the length of the channel that will be occupied by a seated tab 11. The remaining portions 15 of the channels converge slightly so that the two channels are closest to each other at their open ends 9. The side wall channels 14 are parallel to each other and open on both ends. The bottom 4 of the box has tabs 16 for joining the bottom to the sides. The assembly procedure is the same as described above for the wall mounted embodiment.

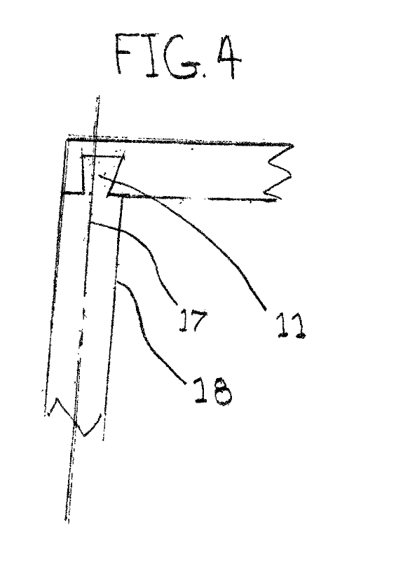

FIG. 4 is a cross sectional top view of this invention's tab and channel joint for planters with flush corners. The design of the tab is the same as illustrated in FIG. 3 except that the tab 11 is offset from the center line 17 of the wall, being located nearer to the wall's inner surface 18.

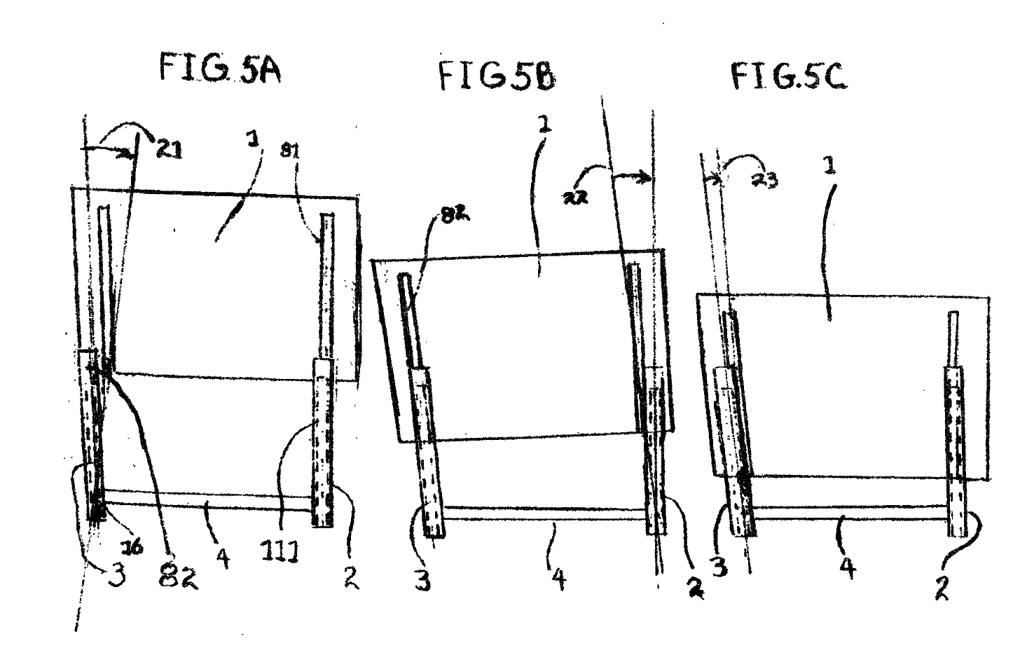

FIGS. 5A, 5B, and 5C demonstrate how and end wall 1, of the embodiment shown in FIG. 1, is joined to the assembled sides 2, 3 and bottom 4. FIG. 5A shows the end wall 1 with channel 81 aligned directly above tab 111 of rear wall 2. The front wall 1 distortion torque required to place tab 3 in the entrance to channel 82 is illustrated by angle 21. The tabs 16 of the bottom 4 are at the fulcrum of the torque.

In FIG. 5B the end wall 1 is partially seated as shown by the penetration of tab 3 into channel 82. The distortion torque at this stage of assembly is smaller than initially as can be seen by comparing angle 22 to angle 21. FIG. 5C shows the continuing decline in side wall distortion as the end wall approaches its final position. See angle 23.

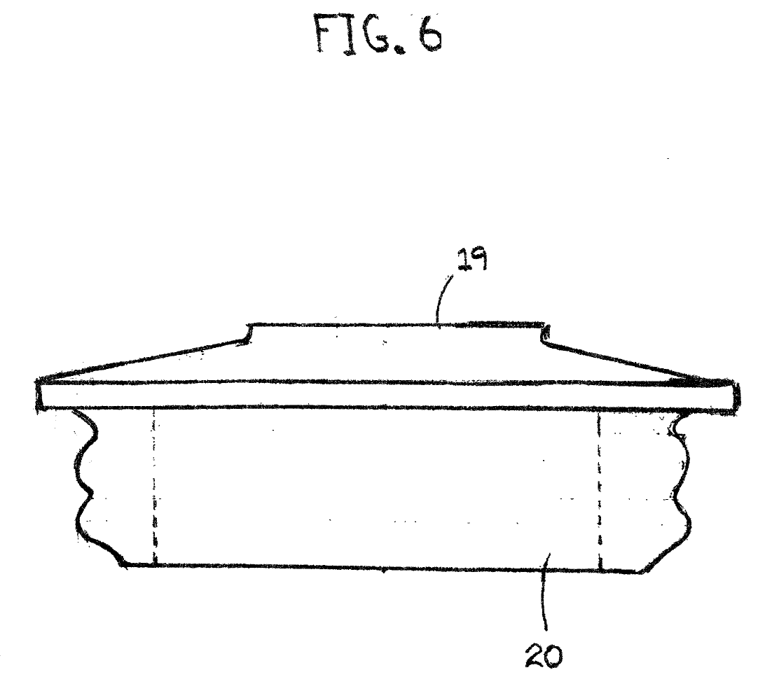

FIG. 6 is a side view of a five piece post cap showing the lid 19 and one of the sides 20.

We claim:

1. A container consisting of at least four side components and a bottom component, said sides and bottom being cut and shaped from composite wood, the inward facing surfaces of the components being essentially flat and the outward facing surfaces of the side components being suitably contoured for decorative purposes.

2. A container consisting of four side components and a lid component, said components being cut and shaped from composite wood, the inward facing surfaces of said components being essentially flat and the outward facing surfaces of said components being suitably contoured for decorative purposes.

3. The container of claim 1 wherein said container is a planter with four side components, each joined at right angles.

4. The container of claim 3 wherein said container has at least two opposing side components that are not parallel to each other.

5. The container of claim 2 wherein said container is a post cap with four equal side components, each joined at right angles.

6. The container of claim 4 wherein the joining mechanism is as follows: 1) two opposing sides of said container each possess a horizontal dove-tailed channel open at both ends and a dove-tailed tab along both vertical edges, 2) a bottom that possesses a dove-tailed tab along two opposite edges, and 3) two opposing sides that each possess two dove-tailed channels open on one end, said channels tending to converge slightly.

7. The container of claim 1 wherein decorative trim is attached to at least one of the side components.
